(19) United States
(12) Patent Application Publication
(10) Pub. No.: US 2009/0244112 A1
(43) Pub. Date: Oct. 1, 2009

(54) DISPLAY APPARATUS AND METHOD THEREOF

(75) Inventors: Jun-ho JUNG, Seoul (KR); Jun-ho SUNG, Seoul (KR); Tae-hyeun HA, Suwon-si (KR); Ki-bum SEONG, Anyang-si (KR); Hyung-rae KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/210,390

(22) Filed: Sep. 15, 2008

(30) Foreign Application Priority Data
Mar. 25, 2008 (KR) 10-2008-0027322

(51) Int. Cl. G09G 5/10; G09G 5/02

(52) U.S. Cl. 345/691; 345/690

(57) ABSTRACT

A display apparatus and method thereof are provided in order to provide a high quality image. The display apparatus includes a driving unit which drives light sources, and a controller which controls the driving unit. Therefore, it is possible to reduce motion blur and flicker and maximize the gray level difference, so that a user may be provided with a clear image.

### CROSS-REFERENCE TO RELATED APPLICATIONS

This application claims priority from Korean Patent Application No. 10-2008-0027322, filed on Mar. 25, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing a display, and more particularly, to providing a display wherein a motion blur effect and flickering effect are eliminated.

2. Description of the Related Art

The recent development of data processing technologies has led to the rapid growth of technologies for displaying information. As a result of the growth of such display technologies, the demand for cathode-ray tubes (CRT) has dropped sharply, while the demand for plate displays such as liquid crystal displays (LCD) has increased considerably.

An LCD provides users with video by transferring light generated by a light source on the rear surface of the LCD to a panel on the front surface through transparent liquid crystals which change according to the voltage applied to the panel. Accordingly, since an LCD is unable to emit light itself, a backlight is additionally required as a light source.

Additionally, an LCD is superior to a CRT in power consumption or space requirements, but has disadvantages such as motion blur, in which any moving object in an image will appear blurred or smeared in the direction of relative motion. This smearing may occur particularly in moving images.

In order to solve these problems, impulse type driving methods are available in which a plurality of light sources of a backlight are made brighter only in certain areas and made dimmer in remaining areas. However, if the impulse type driving method is used, motion blur may be reduced, but flicker may occur, causing monitors to produce a visible flicking effect, so viewers can see all objects appearing or disappearing rapidly.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus and method to eliminate a motion blur effect and flickering effect.

According to an aspect of the present invention, there is provided a display apparatus comprising a driving unit which drives a plurality of light sources arranged in matrix form using a plurality of driving signals which comprises a first driving signal and a second driving signal; and a controller which controls the driving unit so that the frequency or amplitude of the driving signals changes according to whether an image represented by the plurality of light sources is a still image or a moving image.

If the image is determined to be a moving image, the controller may control the driving unit so that the frequency of the first driving signal may be a multiple of the frequency of the second driving signal.

If the image is determined to be a still image, the controller may control the driving unit so that the frequency of the first driving signal may be equal to that of the second driving signal.

If the image shifts from a still image to a moving image, the controller may control the driving unit so that the amplitude of the second driving signal may increase n-fold times but the frequency may be reduced to 1/n.

The controller may control the driving unit so that the amplitude may increase level by level to double the original amplitude.

The controller may control the driving unit so that the amplitude may decrease level by level to 0.

The controller may control the driving unit to alternately perform a first operation for increasing the amplitude level by level to double the original amplitude and a second operation for decreasing the amplitude level by level to 0, so that the amplitude of the second driving signal may double but the frequency may be halved.

If the image shifts from a moving image to a still image, the controller may control the driving unit so that the amplitude of the second driving signal may be reduced to 1/n but the frequency may increase n-fold times.

The controller may control the driving unit so that the amplitude may decrease level by level to half the original amplitude.

The controller may control the driving unit so that the amplitude may increase level by level and that a new pulse may be generated.

The controller may control the driving unit to alternately perform a first operation for decreasing the amplitude level by level to half the original amplitude and a second operation for increasing the amplitude level by level to generate a new pulse, so that the amplitude of the second driving signal may be halved but the frequency may double.

The plurality of driving signals may comprise a plurality of first driving signals and a plurality of second driving signals. Each of the plurality of light sources may be driven by one of the plurality of first driving signals and one of the plurality of second driving signals.

The driving unit may drive the plurality of light sources sequentially in a predetermined order, using a scanning method.

The plurality of light sources may emit light by an impulse type driving method.

The display apparatus may further comprise a converting unit which converts color information of the image into luminance information; and a motion detecting unit which detects luminance changes using the luminance information and determines whether the image is a still image or a moving image according to the detected luminance changes. The controller may control the driving unit according to the result of the determination of the motion detecting unit.

According to another aspect of the present invention, there is provided a display apparatus comprising a driving unit which drives a light source using a driving signal; and a controller which determines whether the type of input image is changed, and gradually changes the amplitude or frequency of the driving signal.

If the input image shifts from a still image to a moving image, the controller may control the driving unit to alternately perform a first operation for increasing the amplitude of the driving signal level by level to double the original amplitude and a second operation for decreasing the amplitude of the driving signal level by level to 0, so that the amplitude of the driving signal may double but the frequency may be halved.

If the input image shifts from a moving image to a still image, the controller may control the driving unit to alternately perform a first operation for decreasing the amplitude of the driving signal level by level to be halved and a second operation for increasing the amplitude of the driving signal level by level to generate a new pulse, so that the amplitude of the driving signal may be halved but the frequency may double.

According to another aspect of the present invention, there is provided a display apparatus comprising a driving unit which generates a driving signal and drives a plurality of light sources arranged in matrix form using a local dimming method; and a controller which controls the driving unit according to whether there is a change in the type of image represented by the plurality of light sources.

If the image shifts from a still image to a moving image, the controller may control the driving unit to alternately perform a first operation for increasing the amplitude of the driving signal level by level to double the original amplitude and a second operation for decreasing the amplitude of the driving signal level by level to 0, so that the amplitude of the driving signal may double but the frequency may be halved.

If the image shifts from a moving image to a still image, the controller may control the driving unit to alternately perform a first operation for decreasing the amplitude of the driving signal level by level to be halved and a second operation for increasing the amplitude of the driving signal level by level to generate a new pulse, so that the amplitude of the driving signal may be halved but the frequency may double.

According to another aspect of the present invention, there is provided a display method comprising driving a plurality of light sources arranged in matrix form using a plurality of driving signals; and controlling the frequency or amplitude of the driving signals to change according to whether an image represented by the plurality of light sources is a still image or a moving image.

The controlling may comprise, if the image is determined to be a moving image, controlling the frequency of a first driving signal to be a multiple of the frequency of a second driving signal.

The controlling may comprise, if the image is determined to be a still image, controlling the frequency of the first driving signal to be equal to that of the second driving signal.

The controlling may comprise, if the image shifts from a still image to a moving image, controlling the amplitude of the second driving signal to increase n-fold times but the frequency to be reduced to 1/n.

The controlling may comprise controlling the amplitude to increase level by level to double the original amplitude.

The controlling may comprise controlling the amplitude to decrease level by level to 0.

The controlling may comprise alternately performing a first operation for increasing the amplitude level by level to double the original amplitude and a second operation for decreasing the amplitude level by level to 0, so that the amplitude of the second driving signal may double but the frequency may be halved.

The controlling may comprise, if the image shifts from a moving image to a still image, controlling the amplitude of the second driving signal to be reduced to 1/n but the frequency to increase n-fold times.

The controlling may comprise controlling the amplitude to decrease level by level to half the original amplitude.

The controlling may comprise controlling the amplitude to increase level by level to generate a new pulse.

The controlling may comprise alternately performing a first operation for decreasing the amplitude level by level to half the original amplitude and a second operation for increasing the amplitude level by level to generate a new pulse, so that the amplitude of the second driving signal may be halved but the frequency may double.

According to another aspect of the present invention, there is provided a display method comprising driving a light source using a driving signal; and determining whether the type of input image is changed, and controlling the amplitude or frequency of the driving signal to gradually change.

The controlling may comprise, if the input image shifts from a still image to a moving image, alternately performing a first operation for increasing the amplitude of the driving signal level by level to double the original amplitude and a second operation for decreasing the amplitude of the driving signal level by level to 0, so that the amplitude of the driving signal may double but the frequency may be halved.

The controlling may comprise, if the input image shifts from a moving image to a still image, alternately performing a first operation for decreasing the amplitude of the driving signal level by level to be halved and a second operation for increasing the amplitude of the driving signal level by level to generate a new pulse, so that the amplitude of the driving signal may be halved but the frequency may double.

According to another aspect of the present invention, there is provided a display method comprising generating a driving signal and driving a plurality of light sources arranged in matrix form using a local dimming method; and controlling the plurality of light sources to be driven according to whether there is a change in the type of image represented by the plurality of light sources.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of a display apparatus according to an exemplary embodiment of the present invention;

FIG. 2 is a block diagram of a backlight driver and a light source unit according to an exemplary embodiment of the present invention;

FIG. 3 illustrates waveforms of a gate signal and source signals supplied to light sources when an image segment is a still image or a moving image, according to an exemplary embodiment of the present invention;

FIGS. 4A and 4B illustrate forms of source signals which vary when an image segment corresponding to a light source changes, according to an exemplary embodiment of the present invention;

FIG. 5 is a flowchart illustrating a method for displaying an image at an initial operation of driving a light source unit, according to an exemplary embodiment of the present invention; and

FIG. 6 is a flowchart illustrating a method for displaying an image after the initial operation of driving the light source unit, according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

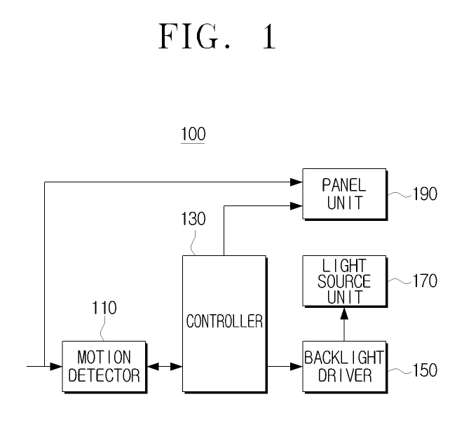

FIG. 1 is a block diagram of a display apparatus 100 according to an exemplary embodiment of the present invention.

The display apparatus 100 of FIG. 1 provides a user with broadcast programs received from broadcast stations or with images stored in a built-in storage medium, so that the user can view the provided programs or images.

The display apparatus 100 of FIG. 1 comprises a motion detector 110, a controller 130, a backlight driver 150, a light source unit 170 and a panel unit 190.

The motion detector 110 receives an image signal representing an input image, and detects motion of image segments corresponding to respective light sources for each image frame.

An image frame comprises a plurality of pixels of the panel unit 190, and each of the image segments corresponding to each of the light sources comprises the pixels among the plurality of pixels which receive light emitted from each of the light sources of the light source unit 170.

For example, if the light source unit 170 includes 100 light sources in a 10×10 grid, and if the panel unit 190 includes 10000 pixels in a 100×100 grid, each of the light sources emits light to 100 pixels in a 10×10 grid. An image represented by the 100 pixels is referred to as an image segment. Accordingly, the number of image segments is equal to the number of light sources forming a single image frame.

In response to the image signal, the motion detector 110 divides each of the image frames into a plurality of image segments, and converts red (R), green (G), blue (B) values of each of the image segments into luminance values. Additionally, the motion detector 110 compares luminance values of image segments of a previous frame to luminance values of image segments of a current frame, to detect motion of image segments.

Specifically, the motion detector 110 extracts R, G, B values of the image segments of the previous frame corresponding to 100 pixels, and then extracts luminance values of the image segments of the previous frame from the extracted R, G, B values. The motion detector 110 also extracts R, G, B values of the image segments of the current frame, and extracts luminance values of the image segments of the current frame from the extracted R, G, B values.

Additionally, the motion detector 110 computes changes in the extracted luminance values for the previous frame and for the current frame, and detects motion of the image segments based on the computed changes.

While the motion of image segments is detected using luminance values in this exemplary embodiment of the present invention for convenience of description, the present invention is also applicable to other methods for detecting motion of image segments, for example motion vectors.

The motion detector 110 detects motion of image segments in order to drive the light source unit 170 using different driving methods according to the type of image segments, for which detailed description thereof will be provided later.

The motion detector 110 sends information regarding the detected motion to the controller 130.

The controller 130 controls the entire operation of the display apparatus 100.

The controller 130 controls the motion detector 110 to receive the information regarding the detected motion from the motion detector 110.

The controller 130 generates a control signal based on the information regarding the detected motion received from the motion detector 110, and transmits the control signal to the backlight driver 150 in order to control the backlight driver 150.

Additionally, the controller 130 controls the panel unit 190 so that an image represented by the image signal is displayed using pixels.

The backlight driver 150 receives the control signal from the control unit 130 and generates a driving signal to drive the light source unit 170, in response to the control signal.

The light source unit 170 includes a plurality of light sources arranged in matrix form. The light source unit 170 emits light to the panel unit 190 in response to the driving signal generated by the backlight driver 150.

The panel unit 190 includes a plurality of pixels and generates an image using the plurality of pixels.

The panel unit 190 receives the image signal, and the plurality of pixels of the pixel unit 190 are used to display an image using the received image signal and the light emitted from the light source unit 170.

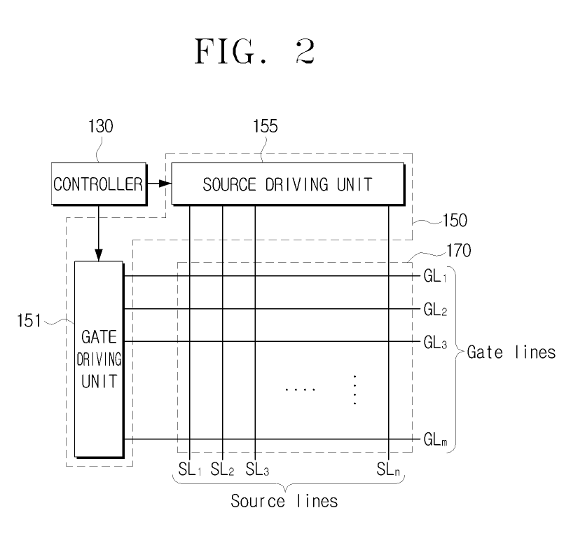

FIG. 2 is a block diagram of the backlight driver 150 and the light source unit 170 shown in FIG. 1. In order to facilitate understanding of the present invention, FIG. 2 also shows the controller 130.

The controller 130 transmits the control signal to the backlight driver 150. The backlight driver 150 generates a driving signal in response to the control signal, and drives the light source unit 170 using the generated driving signal. The driving signal comprises a gate signal and source signal.

The backlight driver 150 comprises a gate driving unit 151, which generates gate signals and supplies the gate signals to gate lines of the light source unit 170, and a source driving unit 155, which generates source signals and supplies the source signals to source lines of the light source unit 170.

The gate driving unit 151 supplies gate signals to m gate lines, namely GL₁ to GLₘ. Specifically, the gate driving unit 151 divides the plurality of light sources into light sources to be made brighter and light sources to be made dimmer, and supplies impulse type gate signals to gate lines having the light sources to be made brighter.

The source driving unit 155 supplies source signals to n gate lines, namely SL₁ to SLₙ. Specifically, the source driving unit 155 divides the plurality of light sources into light sources to be made brighter and light sources to be made dimmer, and supplies impulse type source signals to source lines having the light sources to be made brighter.

Additionally, the source driving unit 155 supplies still image source signals and moving image source signals to light sources corresponding to image segments which are still images and to light sources corresponding to image segments which are moving images, respectively.

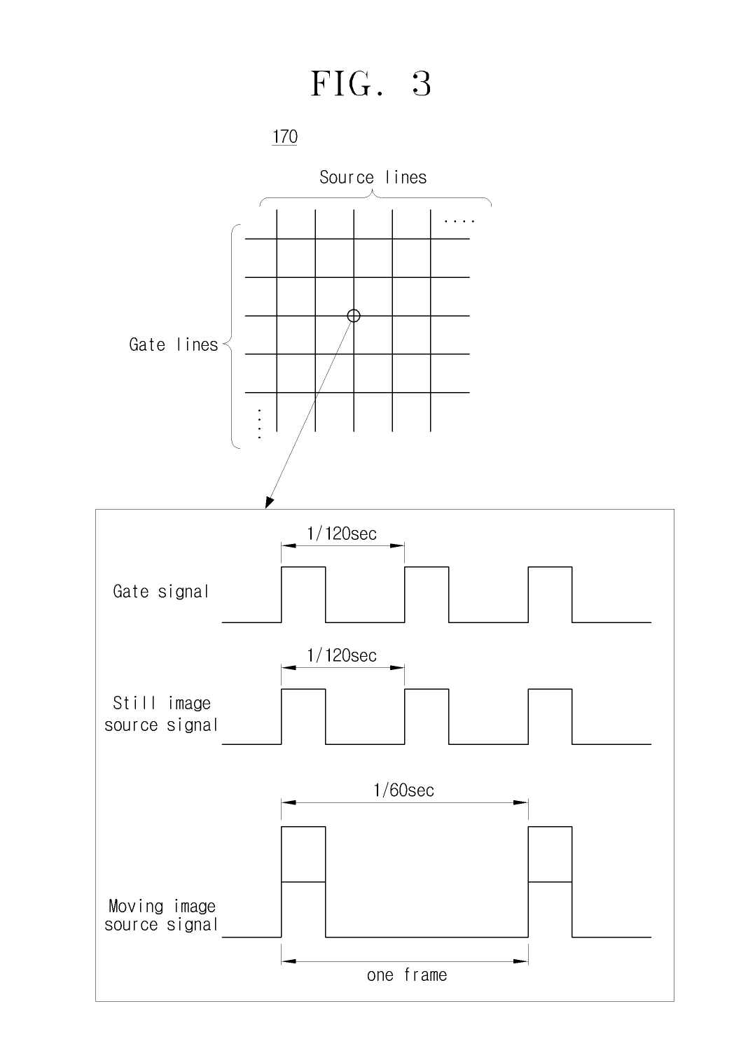

The still image source signals and moving image source signals will be described in detail later with reference to FIG. 3.

The light source unit 170 comprises m×n light sources. Here, m indicates the number of gate lines, and n indicates the number of source lines. In other words, the light sources of the light source unit 170 are arranged in the form of a matrix having m gate lines and n source lines.

FIG. 3 illustrates waveforms of a gate signal and source signals supplied to light sources when an image segment is a still image or a moving image.

In order to facilitate understanding of the present invention, a situation in which a gate signal and source signals are supplied to a 3×3 light source belonging to a third gate line and third source line, is described with reference to FIG. 3. Additionally, the frequency of an image signal input to the display apparatus 100 is approximately 60 Hz.

The controller 130 controls each of the light sources to be driven by the still image source signals or moving image source signals according to whether image segments corresponding to the light sources are still images or moving images.

The gate signal, still image source signals and moving image source signals are supplied in an impulse type manner, so each of the light sources may be driven by an impulse type driving method and may emit light by an impulse type radiating method.

The impulse type driving method prevents motion blur from occurring when a moving image and high speed image are displayed by a hold type driving method.

Method for driving light sources may be divided into an impulse type driving method, which may be applied to a cathode-ray tube (CRT), and a hold type driving method, in which light sources may be brightened while a single frame is displayed. The hold type driving method has the disadvantage of motion blur, in which any moving object in an image will appear blurred or smeared in the direction of relative motion.

Accordingly, according to this exemplary embodiment of the present invention, in order to eliminate such a motion blur effect, the impulse type driving method is used, so that the gate driving unit 151 and source driving unit 155 may supply impulse type gate signals and impulse type source signals to the light source unit 170, respectively.

The impulse type driving method may be either a data blinking method or a scanning backlight method.

The data blinking method allows actual image data and black data to alternately appear in an image signal output to the panel unit 190. The scanning backlight method allows actual image data to be input to an image signal output to the panel unit 190 and makes light sources brighter or dimmer sequentially.

This exemplary embodiment of the present invention relates to the scanning backlight method, in which the light sources of the light source unit 170 are turned on and off in sequence.

According to the exemplary embodiment of the present invention, the backlight driving unit 150 drives the light source unit 170 using a local dimming method.

The local dimming method refers to a method in which the light source unit 170 is divided into a plurality of areas and driving signals are applied to only required areas among the plurality of areas in order to emit light. If the local dimming method is used, power consumption may be reduced and the gray level difference may be maximized.

However, the above description is merely an example for convenience of description, and any method for driving the light source unit 170 may be applied to the present invention instead of the local dimming method.

If a predetermined number of pixels or less among pixels of an image segment corresponding to a light source have fixed luminance values, or if luminance values of the predetermined number of pixels or less are reduced to a predetermined level or less, the image segment is determined to be a still image.

For example, if an image segment corresponding to the 3×3 light source is represented by 100 pixels, and if luminance values of 10 pixels or fewer of the 100 pixels change, the image segment is determined to be a still image.

If a predetermined number of pixels or more among pixels of an image segment corresponding to a light source have variable luminance values, or if luminance values of the predetermined number or more of pixels increase to a predetermined level or higher, the image segment is determined to be a moving image.

For example, if an image segment corresponding to the 3×3 light source is represented by 100 pixels, and if luminance values of at least 90 pixels of the 100 pixels change, the image segment is determined to be a moving image.

While the motion of image segments is detected according to changes in the luminance values in this exemplary embodiment, the present invention is also applicable to situations in which determination of whether image segments are still images or moving images is made according to other criteria.

The controller 130 receives information regarding whether motion is detected from the motion detector 110, and determines frame by frame whether each image segment corresponding to each light source is a still image or a moving image. For example, if the light source unit 170 comprises 100 light sources, the controller 130 may determine the type of image segments, namely still images or moving images, one hundred times for each frame.

If the image segment corresponding to the 3×3 light source is determined to be a still image, the controller 130 controls the backlight driver 150 so that a gate signal and a still image source signal are supplied to the 3×3 light source of the light source unit 170.

The gate signal and still image source signal are supplied at a frequency of approximately 120 Hz, twice that of the image signal, in order to prevent flicker from occurring while viewing video.

Flicker causes a screen to produce a visible flickering effect according to the on/off frequency of each of the light sources when the on/off frequency of each the light sources is equal to the frequency of the image signal.

Flicker may occur when light sources are driven at a frequency low enough to be noticed by users. For example, if a light source is driven at a frequency of approximately 60 Hz, equal to that of the image signal, a flickering effect may be observed because a user is able to notice a frequency of 60 Hz. Accordingly, the backlight driver 150 may drive the light sources at a frequency of approximately 120 Hz, twice that of the image signal, so the user is not able to perceive the flickering effect and flicker can be reduced.

Therefore, if an image segment is a still image, a gate signal and still image source signal are supplied to the light source unit 170 at a frequency twice that of the image signal and become synchronized with the image signal.

If the image segment corresponding to the 3×3 light source is determined to be a moving image, the controller 130 controls the backlight driver 150 so that a gate signal and a moving image source signal are supplied to the 3×3 light source of the light source unit 170.

The gate signal is supplied at a frequency of approximately 120 Hz, twice that of the image signal, while the moving image source signal is supplied at a frequency of approximately 60 Hz, equal to that of the image signal, in order to reduce motion blur in moving images.

Motion blur may cause any moving object in an image to look blurred or smeared in the direction of relative motion, as described above.

This smearing generally occurs when light sources are driven using the hold type driving method, so the impulse type driving method may preferrably be used. However, the response time of each pixel of the panel unit 190 is slower than that of a CRT, so if the light source unit 170 is driven at approximately 120 Hz, light sources may emit light at inappropriate times, thereby causing motion blur.

Since such motion blur may occur in moving images, the moving image source signal is supplied at a frequency equal to that of the image signal so that light sources may emit light at appropriate times to minimize motion blur.

Accordingly, if an image segment is a moving image, the gate signal output to the light source unit 170 has a frequency twice that of the image signal and is synchronized with the image signal. Additionally, the moving image source signal output to the light source unit 170 has the same frequency as the image signal and is synchronized with the image signal.

Therefore, if the image signal has a frequency of approximately 60 Hz, the gate signal and still image source signal may have a frequency of approximately 120 Hz, and the moving image source signal may have a frequency of approximately 60 Hz.

The moving image source signal has an amplitude twice that of the still image source signal. The frequency of the moving image source signal is half the frequency of the gate signal, and the still image source signal has the same frequency as the gate signal, so the moving image source signal has a frequency half that of the still image source signal.

When comparing a situation in which an image segment is a still image to a situation in which an image segment is a moving image, the amount of light emitted by the light source unit 170 when an image segment is a still image is twice that of light emitted when an image segment is a moving image. Accordingly, in order to maintain uniform brightness of a single frame, the moving image source signal has an amplitude twice that of the still image source signal.

As described above, the controller 130 determines whether to supply a still image source signal or moving image source signal, according to information regarding whether each image segment corresponding to each light source is a still image or moving image.

While the image signal has a frequency of approximately 60 Hz in this exemplary embodiment of the present invention for convenience of description, the present invention is equally applicable to a situation in which an image signal is received at a frequency other than 60 Hz, for example 50 Hz or 120 Hz.

For example, if an image signal is received at a frequency of 120 Hz, the gate signal and still image source signal may be received at a frequency of 240 Hz, and the moving image source signal may be received at a frequency of 120 Hz.

Additionally, for convenience of description, the frequency of the gate signal in the present invention is 120 Hz, twice the frequency of the image signal as described above, but there is no limitation in having the gate signal at other multiples of the image signal. Accordingly, the present invention is equally applicable to a situation in which the gate signal is received at a frequency multiple of that of an image signal in order to prevent flicker from occurring and to be synchronized with the image signal. In this situation, the amplitude of the moving image source signal may increase as the frequency of the image signal increases.

For example, if the gate signal is received at a frequency of 180 Hz, three times that of the image signal, the still image source signal may also have a frequency of 180 Hz, but the moving image source signal may have a frequency of 60 Hz, one-third of that of the still image source signal. On the other hand, in order to maintain uniform brightness of a single frame, the moving image source signal may have an amplitude three times that of the still image source signal.

Furthermore, in the exemplary embodiment of the present invention, a determination of whether to supply a still image source signal or moving image source signal is made according to whether each image segment corresponding to each light source is a still image or moving image for convenience of description, but there is no limitation thereto. Accordingly, the present invention is equally applicable to a situation in which a determination of whether to supply a still image source signal or moving image source signal is made according to whether an image frame comprising a plurality of image segments is a still image or moving image.

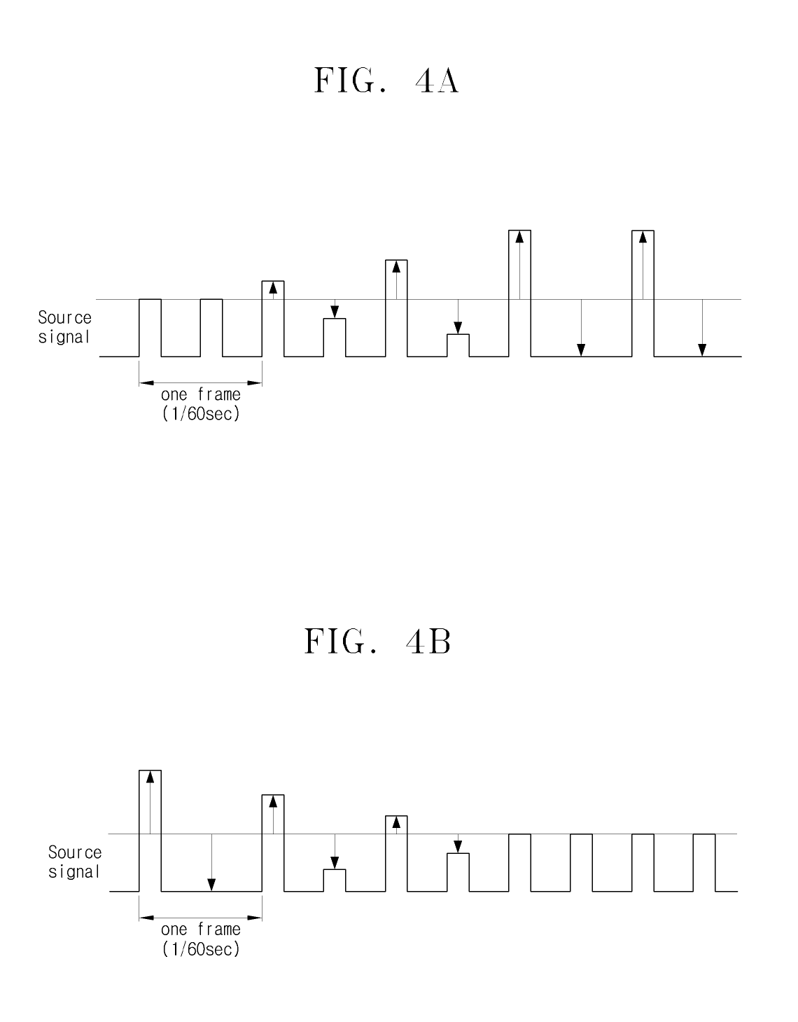

FIG. 4A illustrates a waveform of a source signal which varies when an image segment corresponding to a light source shifts from a still image to a moving image, according to an exemplary embodiment of the present invention.

In FIG. 4A, the waveform of the source signal before the image segment starts to change to a moving image is identical to that of the still image source signal shown in FIG. 3, but the waveform of the source signal after the image segment completely changes to a moving image is identical to that of the moving image source signal shown in FIG. 3.

In order to prevent the light source from instantly becoming different from other light sources in brightness when the image segment changes from the still image to the moving image, the shape of the image source signal is gradually changed from the waveform of the still image source signal to the waveform of the moving image source signal, rather than being changed instantly. In an exemplary embodiment, the gradual change takes place in a stepwise manner as shown in FIGS. 4A and 4B.

For example, in the case of the image segment corresponding to the 3×3 light source, if a still image source signal is input at the second frame and a moving image source signal is input at the third frame, there is an interval of 1/120 second between the still image source signal and moving image source signal. Accordingly, it is possible to maintain an interval between a source signal input at the first frame and a source signal input at the second frame.

However, since the source signal input at the third frame has an amplitude twice that of the source signals input at the first frame and second frame, the luminance of the 3×3 light source may instantly increase relative to other light sources.

In order to solve such problems, the waveform of the image source signal is not abruptly changed from the waveform of the still image source signal to the waveform of the moving image source signal, but gradual changes are made to the image source signal to end up with the shape of the moving image source signal.

As described above for FIG. 4A, if a still image source signal is input at the first frame and a moving image source signal is gradually input starting at the second frame, the image source signal may change from the shape of the still image source signal at the first frame to the shape of the moving image source signal at the fourth frame after passing through a transitional period of two frames of the second frame and third frame.

If the image segment that is a moving image at the second frame is changed to a still image at the third frame, the source signal of the image segment may have the same form as the still image source signal at the first frame.

Alternatively, if the image segment that is a still image at the second frame and third frame is changed to a moving image at the fourth frame, the still image source signal may be input at the second frame, rather than being input directly at the fourth frame.

Accordingly, when an image segment corresponding to a light source changes from a still image to a moving image, the light source may be driven without having any difference in brightness from other light sources.

FIG. 4B illustrates a waveform of a source signal which varies when an image segment corresponding to a light source shifts from a moving image to a still image, according to an exemplary embodiment of the present invention.

As described above regarding FIG. 4A, the waveform of the source signal before the image segment changes to a still image is identical to that of the moving image source signal shown in FIG. 3, but the waveform of the source signal after the image segment changes to a still image is identical to that of the still image source signal shown in FIG. 3.

In order to prevent the light source from instantly becoming different from other light sources in brightness when the image segment changes from the moving image to the still image, the shape of the image source signal is gradually changed from the waveform of the moving image source signal to the waveform of the still image source signal, rather than being changed instantly.

For example, in the case of the image segment corresponding to the 3×3 light source, if a moving image source signal is input at the second frame and a still image source signal is input at the third frame, there is an interval of 1/120 second between the still image source signal and moving image source signal. Accordingly, it is possible to maintain an interval between a source signal input at the first frame and a source signal input at the second frame.

However, since the source signal input at the third frame has an amplitude, half that of the source signals input at the first frame and second frame, the luminance of the 3×3 light source may instantly decrease relative to other light sources.

In order to solve such problem, the waveform of the image source signal is not abruptly changed from the waveform of the moving image source signal to the waveform of the still image source signal, but gradual changes are made to the image source signal to end up with the shape of the still image source signal.

As described above for FIG. 4B, if a moving image source signal is input at the first frame and a still image source signal is gradually input starting at the second frame, the image source signal may change from the shape of the moving image source signal at the first frame to the shape of the still image source signal at the fourth frame after passing through a transitional period of two frames of the second frame and third frame.

If the image segment that is a still image at the second frame is changed to a moving image at the third frame, the source signal of the image segment may have the same form as the moving image source signal at the first frame.

Alternatively, if the image segment that is a moving image at the second frame and third frame is changed to a still image at the fourth frame, the moving image source signal may be input at the second frame, rather than being input directly at the fourth frame.

Accordingly, when an image segment corresponding to a light source changes from a moving image to a still image, the light source may be driven without having any difference in brightness from other light sources.

As described above, if each image segment corresponding to each light source shifts from a still image to a moving image or from a moving image to a still image, the source signal is transformed through two frames in the exemplary embodiment of the present invention for convenience of description, but there is no limitation to two frames. Accordingly, the present invention is equally applicable to a situation in which the source signal is transformed through a single frame or through three or more frames.

Additionally, in the exemplary embodiment of the present invention, the display apparatus determines whether to change a source signal according to whether each image segment corresponding to each light source is a still image or a moving image for convenience of description, but there is no limitation thereto. Accordingly, the present invention is also applicable to a situation in which the display apparatus determines whether to change a source signal according to whether a single image frame is a still image or a moving image.

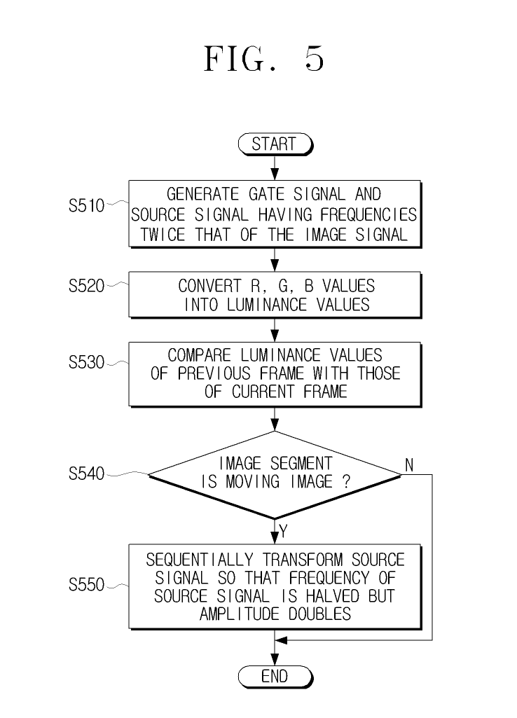

FIG. 5 is a flowchart illustrating a method for displaying an image at the initial operation of driving the light source unit 170, according to an exemplary embodiment of the present invention.

The backlight driver 150 receives the control signal output from the controller 130, and generates a gate signal and a still image source signal, which have frequencies twice the frequency of the image signal (S510). Here, the still image source signal has the same frequency as the gate signal.

The controller 130 converts R, G, B values of each of the image segments corresponding to the respective light sources into luminance values (S520).

If the controller 130 transmits the converted luminance values to the motion detector 110, the motion detector 110 compares the luminance values of the previous frame with those of the current frame, and detects whether there is motion between the image segments (S530).

The controller 130 determines whether each of the image segments corresponding to each of the light sources of the current frame is a still image or a moving image, according to information detected in operation S530 (S540).

If an image segment is determined to be a moving image (S540-Y), the controller 130 controls the backlight driver 150 to sequentially transform a source signal of the image segment so that the frequency of the source signal is halved but the amplitude doubles (S550). In more detail, according to the control of the controller 130, the backlight driver 150 gradually changes the waveform of the image source signal from the waveform of still image source signal to that of the moving image source signal.

Alternatively, if an image segment is determined to be a still image (S540-N), the controller 130 controls the backlight driver 150 so that the current waveform of the source signal may be maintained.

Accordingly, it is possible for the user to view an image from which motion blur and flicker are eliminated.

While the still image source signal is input first during the initial operation of driving the light source unit 170 in this exemplary embodiment of the present invention, there is no limitation thereto. This is because when the first frame is input when there is no previous frame, and thus it is impossible to determine whether an image segment is a still image or a moving image. Accordingly, the present invention is also applicable to a situation in which a moving image source signal is input first during the initial operation of driving the light source unit 170.

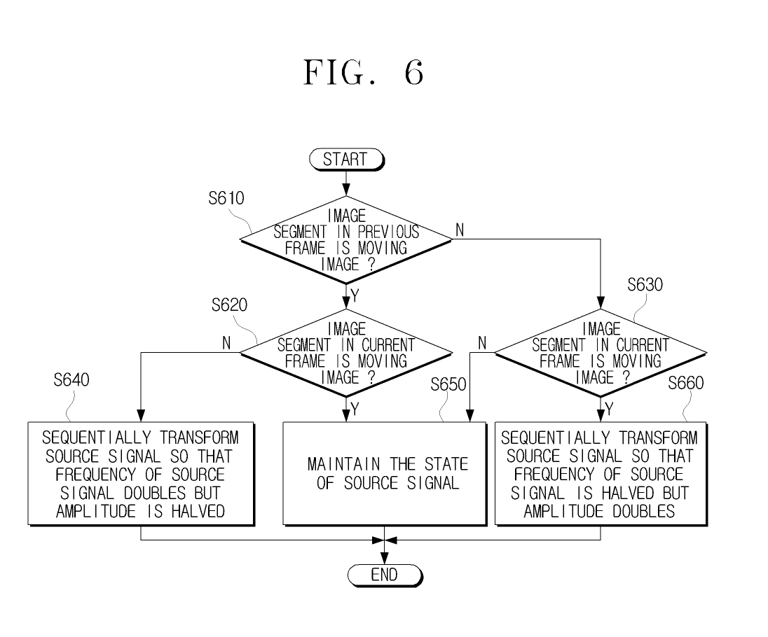

FIG. 6 is a flowchart illustrating a method for displaying an image after the initial operation of driving the light source unit 170, according to an exemplary embodiment of the present invention.

The process for determining whether an image segment is a still image or a moving image has been described above, so a process for transforming a source signal according to the result of such determination will be described hereinafter.

The controller 130 determines whether an image segment corresponding to a light source in the previous frame is a moving image (S610).

If the image segment in the previous frame is determined to be a moving image (S610-Y), the controller 130 determines whether an image segment in the current frame is a moving image (S620).

If the image segment in the current frame is determined to be a moving image (S620-Y), the controller 130 maintains the current waveform of the source signal. In other words, the state of the moving image source signal, of which the frequency is half that of the gate signal and the amplitude is twice that of the gate signal, may also be maintained in the current frame.

Alternatively, if the image segment in the current frame is determined to be a still image (S620-N), the controller 130 sequentially transforms the source signal of the image segment so that the frequency of the source signal doubles but the amplitude is halved (S640).

If the image segment in the previous frame is determined to be a still image (S610-N), the controller 130 determines whether the image segment in the current frame is a moving image (S630).

If the image segment in the current frame is determined to be a moving image (S630-Y), the controller 130 sequentially transforms the source signal of the image segment so that the frequency of the source signal is halved but the amplitude doubles (S660).

Alternatively, if the image segment in the current frame is determined to be a still image (S630-N), the controller 130 maintains the current waveform of the source signal (S650). The source signal is also maintained as a still image source signal in the current frame so that the frequency of the source signal is equal to that of the gate signal and the amplitude of the source signal is equal to that of the gate signal.

As described above, according to exemplary embodiments of the present invention, various light source driving methods are used according to whether image segments corresponding to light sources move or not, so it is possible to reduce motion blur and flicker and maximize the gray level difference, thereby providing a user with a cleaner image.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
a driving unit which drives a plurality of light sources arranged in matrix form using a plurality of driving signals which comprises a first driving signal and a second driving signal; and
a controller which controls the driving unit so that a frequency or an amplitude of the driving signals changes according to whether an image represented by the plurality of light sources is a still image or a moving image.

2. The display apparatus as claimed in claim 1, wherein, if the image is determined to be the moving image, the controller controls the driving unit so that a frequency of the first driving signal is a multiple of a frequency of the second driving signal.

3. The display apparatus as claimed in claim 1, wherein, if the image is determined to be the still image, the controller controls the driving unit so that a frequency of the first driving signal is equal to a frequency of the second driving signal.

4. The display apparatus as claimed in claim 1, wherein, if the image shifts from being the still image to the moving image, the controller controls the driving unit so that a first amplitude of the second driving signal increases n-fold times and a frequency of the second driving signal is reduced by 1/n.

5. The display apparatus as claimed in claim 4, wherein the controller controls the driving unit so that the first amplitude increases stepwise to double the first amplitude.

6. The display apparatus as claimed in claim 4, wherein the controller controls the driving unit so that a second amplitude of the second driving signal decreases stepwise to 0.

7. The display apparatus as claimed in claim 4, wherein the controller controls the driving unit to alternately perform a first operation for increasing the first amplitude stepwise to double the first amplitude and a second operation for decreasing a second amplitude of the second driving signal stepwise to 0, so that the first amplitude of the second driving signal doubles but the frequency of the second driving signal is halved.

8. The display apparatus as claimed in claim 1, wherein, if the image shifts from being the moving image to the still image, the controller controls the driving unit so that a first amplitude of a driving signal is reduced to 1/n but a frequency of the driving signal increases n-fold times.

9. The display apparatus as claimed in claim 8, wherein the controller controls the driving unit so that the first amplitude decreases stepwise to half of the first amplitude.

10. The display apparatus as claimed in claim 8, wherein the controller controls the driving unit so that the first amplitude increases stepwise and a new pulse is generated.

11. The display apparatus as claimed in claim 8, wherein the controller controls the driving unit to alternately perform a first operation for decreasing a second amplitude of the driving signal stepwise to half of the second amplitude and a second operation for increasing the first amplitude stepwise to generate a new pulse, so that the second amplitude of the driving signal is halved but the frequency of the driving signal doubles.

12. The display apparatus as claimed in claim 1, wherein the plurality of driving signals comprise a plurality of first driving signals and a plurality of second driving signals, and
each of the plurality of light sources is driven by one of the plurality of first driving signals and one of the plurality of second driving signals.

13. The display apparatus as claimed in claim 1, wherein the driving unit drives the plurality of light sources sequentially in a predetermined order, using a scanning.

14. The display apparatus as claimed in claim 1, wherein the plurality of light sources emit light by impulse type driving.

15. The display apparatus as claimed in claim 1, further comprising:
a converting unit which converts color information of the image into luminance information; and
a motion detecting unit which detects luminance changes using the luminance information and determines whether the image is the still image or the moving image according to the detected luminance changes to generate a result,
wherein the controller controls the driving unit according to the result of the determination of the motion detecting unit.

16. A display apparatus comprising:
a driving unit which drives a light source using a driving signal; and
a controller which determines whether a type of input image is changed, and gradually changes an amplitude of the driving signal or changes a frequency of the driving signal.

17. The display apparatus as claimed in claim 16, wherein, if the input image shifts from being the still image to the moving image, the controller controls the driving unit to alternately perform a first operation for increasing a first amplitude of the driving signal stepwise to double the first amplitude and a second operation for decreasing a second amplitude of the driving signal stepwise to 0, so that the first amplitude of the driving signal doubles and the frequency is halved.

18. The display apparatus as claimed in claim 16, wherein, if the input image shifts from being the moving image to the still image, the controller controls the driving unit to alternately perform a first operation for decreasing a first amplitude of the driving signal stepwise to be halved and a second operation for increasing a second amplitude of the driving signal stepwise to generate a new pulse, so that the first amplitude of the driving signal is halved but the frequency doubles.

19. A display apparatus comprising:
a driving unit which generates a driving signal and drives a plurality of light sources arranged in matrix form using a local dimming method; and
a controller which controls the driving unit according to whether there is a change in a type of image represented by the plurality of light sources.

20. The display apparatus as claimed in claim 19, wherein, if the image shifts from being a still image to a moving image, the controller controls the driving unit to alternately perform a first operation for increasing a first amplitude of the driving signal stepwise to double the first amplitude and a second operation for decreasing a second amplitude of the driving signal stepwise to 0, so that the first amplitude of the driving signal doubles but a frequency is halved.

21. The display apparatus as claimed in claim 19, wherein, if the image shifts from being a moving image to a still image, the controller controls the driving unit to alternately perform a first operation for decreasing a first amplitude of the driving signal stepwise to be halved and a second operation for increasing a second amplitude of the driving signal stepwise to generate a new pulse, so that the first amplitude of the driving signal is halved but a frequency of the driving signal doubles.

22. A display method comprising:
driving a plurality of light sources arranged in matrix form using a plurality of driving signals; and
controlling a frequency or an amplitude of the driving signals to change according to whether an image represented by the plurality of light sources is a still image or a moving image.

23. The display method as claimed in claim 22, wherein the controlling comprises, if the image is determined to be the moving image, controlling a frequency of a first driving signal to be a multiple of a frequency of a second driving signal.

24. The display method as claimed in claim 22, wherein the controlling comprises, if the image is determined to be the still image, controlling a frequency of a first driving signal to be equal to a frequency of a second driving signal.

25. The display method as claimed in claim 22, wherein the controlling comprises, if the image shifts from being the still image to the moving image, increasing a first amplitude of a second driving signal n-fold times and reducing a frequency of the second driving signal is reduced by 1/n.

26. The display method as claimed in claim 25, wherein the controlling comprises controlling the first amplitude to increase stepwise to double the first amplitude.

27. The display method as claimed in claim 25, wherein the controlling comprises controlling a second amplitude of the second driving signal to decrease stepwise to 0.

28. The display method as claimed in claim 25, wherein the controlling comprises alternately performing a first operation for increasing the first amplitude stepwise to double the first amplitude and a second operation for decreasing a second amplitude of the second driving signal stepwise to 0, so that the first amplitude of the second driving signal doubles but the frequency is halved.

29. The display method as claimed in claim 22, wherein the controlling comprises, if the image shifts from being the moving image to the still image, controlling a first amplitude of a second driving signal to be reduced to 1/n but a frequency of the second driving signal increases n-fold times.

30. The display method as claimed in claim 29, wherein the controlling comprises controlling the first amplitude to decrease stepwise to half of the first amplitude.

31. The display method as claimed in claim 29, wherein the controlling comprises controlling the first amplitude to increase step by step to generate a new pulse.

32. The display method as claimed in claim 29, wherein the controlling comprises alternately performing a first operation for decreasing a second amplitude of the driving signal stepwise to half of the second amplitude and a second operation for increasing the first amplitude stepwise to generate a new pulse, so that the second amplitude of the second driving signal is halved but the frequency of the second driving signal doubles.

33. A display method comprising:
driving a light source using a driving signal; and
determining whether a type of input image is changed, and controlling an amplitude or a frequency of the driving signal to gradually change.

34. The display method as claimed in claim 33, wherein the controlling comprises, if the input image shifts from being the still image to the moving image, alternately performing a first operation for increasing a first amplitude of the driving signal stepwise to double the first amplitude and a second operation for decreasing a second amplitude of the driving signal stepwise to 0, so that the first amplitude of the driving signal doubles but the frequency is halved.

35. The display method as claimed in claim 33, wherein the controlling comprises, if the input image shifts from being the moving image to the still image, alternately performing a first operation for decreasing a first amplitude of the driving signal stepwise to be halved and a second operation for increasing a second amplitude of the driving signal stepwise to generate a new pulse, so that the first amplitude of the driving signal is halved but the frequency doubles.

36. A display method comprising:
generating a driving signal and driving a plurality of light sources arranged in matrix form using a local dimming method; and
controlling the plurality of light sources to be driven according to whether there is a change in a type of image represented by the plurality of light sources.
